(19) United States
(12) Patent Application Publication
(10) Pub. No.: US 2022/0376274 A1
(43) Pub. Date: Nov. 24, 2022

(54) COLD-HOT COMPONENT SUPPORT STRUCTURE AND SOLID OXIDE FUEL CELL HEAT INSULATION SUPPORT STRUCTURE

(71) Applicant: Ceres Intellectual Property Company Limited, Horsham West Sussex (GB)

(72) Inventors: Chunlei Gao, Weifang, Shandong (CN); Hongmin Cao, Weifang, Shandong (CN); Meng Cao, Weifang, Shandong (CN); Yi Zhang, Weifang, Shandong (CN)

(21) Appl. No.: 17/764,126

(22) PCT Filed: Sep. 30, 2020
(86) PCT No.: PCT/IB2020/059156

§ 371 Date: Mar. 25, 2022

(30) Foreign Application Priority Data
Sep. 30, 2019 (CN) 201921674009.5

(51) Int. Cl. H01M 8/04007

(52) U.S. Cl. CPC H01M 8/04007; H01M 2008/1293

(57) ABSTRACT

A cold-hot component support structure, comprising a base and a connected support connected on the base by a bolt, wherein a bolt mounting hole is provided on the connected support, and an upper end face and a lower end face of the connected support are provided with an upper heat insulation block and a lower heat insulation block respectively. The lower heat insulation block is provided with a limit hole connecting the bolt mounting hole, and the upper heat insulation block is extended with a limit sleeve inserted in the limit hole. The supported support is clamped between the upper heat insulation block and the lower heat insulation block by an insertion structure between the upper heat insulation block and the lower heat insulation block, and an inner wall of a bolt hole on the connected support is insulated by the limit sleeve, so as to realize effective heat insulation of the connected support and reduce heat loss of the connected support. The structure can form part of a solid oxide fuel cell (SOFC) heat insulation support structure.

### TECHNICAL FIELD

The present invention relates to the technical field of mechanical connection, and more specifically, to a cold-hot component support structure and an SOFC heat insulation support structure.

### BACKGROUND ART

FIG. 1 is a schematic diagram of a cold-hot component connection structure in which a layer of heat insulation plates 3′ is clamped between a connected high temperature part 11′ and a base fixing plate 2′, and then fixed by a bolt 4′. Direct connection of the cold-hot component will lose a lot of heat due to heat transfer, and a layer of heat insulation plates 3′ is added between cold and hot components, which will reduce heat transfer to a certain extent, but the bolt 4′ is contacted with the cold and hot components in this structure, thus there is a part of energy capable of being transferred by a path consisting of the connected high temperature part 11′, base fixing plate 2′ and the bolt 4′, consequently to reduce the heat efficiency of the system.

Therefore, how to reduce the heat efficiency loss in connection of cold and hot components is a problem.

### SUMMARY OF THE INVENTION

The present invention provides a cold-hot component support structure, in order to reduce the heat efficiency loss in connection of cold and hot components. The invention also provides a solid oxide fuel cell (SOFC) heat insulation support structure.

A first aspect of the invention provides a cold-hot component support structure, comprising a base and a connected support connected on the base by a bolt, wherein a bolt mounting hole is provided on the connected support, and an upper end face and a lower end face of the connected support are provided with an upper heat insulation block and a lower heat insulation block, respectively. The lower heat insulation block is provided with a limit hole connecting the bolt mounting hole, and the upper heat insulation block is extended with a limit sleeve inserted in the limit hole.

The bolt mounting hole, the limit hole, and the limit sleeve can be arranged coaxially.

An outer wall of the limit sleeve can be closely matched with an inner wall of the limit hole.

An inner hole of the limit sleeve can be closely matched with an outer ring of the bolt.

A bolt connection hole closely matched with the outer ring of the bolt can be provided on the lower heat insulation block.

The upper heat insulation block and the lower heat insulation block can both be mica heat insulation blocks.

A second aspect of the invention provides an SOFC heat insulation support structure, comprising a mounting support for erecting an SOFC and a mounting base for erecting the support, wherein the cold-hot component support structure according to the first aspect is provided between the mounting support and the mounting base.

The cold-hot component support structure provided by the present invention comprises a base and a connected support connected on the base by a bolt, wherein a bolt mounting hole is provided on the connected support, and an upper end face and a lower end face of the connected support are provided with an upper heat insulation block and a lower heat insulation block, respectively; The lower heat insulation block is provided with a limit hole connecting the bolt mounting hole, and the upper heat insulation block is extended with a limit sleeve inserted in the limit hole. The lower end face of the connected support is lapped on the base through the lower heat insulation block, and the upper end face and a nut of the bolt are supported by the upper heat insulation block; the limit hole and the limit sleeve are provided between the upper heat insulation block and the lower heat insulation block, and the limit sleeve is inserted in the limit hole; the bolt is locked on the base through the upper heat insulation block, connected support and the lower heat insulation block; the supported support is clamped between the upper heat insulation block and the lower heat insulation block by an insertion structure between the upper heat insulation block and the lower heat insulation block, and an inner wall of a bolt hole on the connected support is insulated by the limit sleeve, so as to realize effective heat insulation of the connected support and reduce heat losses of the connected support.

### BRIEF DESCRIPTION OF THE DRAWINGS

The drawings used in the description of the embodiments will be briefly described below. The drawings in the description below are just some embodiments of the present invention.

FIG. 1 is a schematic diagram of a cold-hot component connection structure.

FIG. 2 is a schematic diagram of the cold-hot component support structure provided by the present invention.

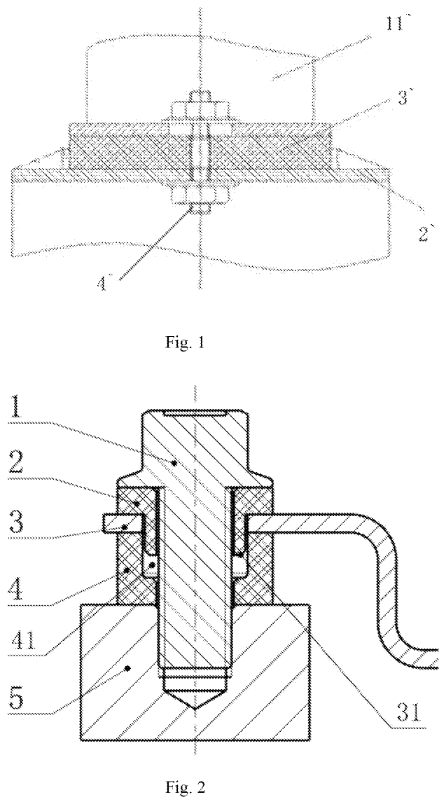

### DETAILED DESCRIPTION

The present invention provides a cold-hot component support structure, in order to reduce the heat efficiency loss in connection of cold and hot components. The invention also provides a solid oxide fuel cell (SOFC) heat insulation support structure.

Embodiments of the present invention will be described below in conjunction with the drawings. The described embodiments are only some, not all, of the embodiments of the present invention.

FIG. 2 is a schematic diagram of the cold-hot component support structure provided by the present invention.

This embodiment provides a cold-hot component support structure, comprising a base 5 and a connected support 3 connected on the base 5 by a bolt 1, wherein a bolt mounting hole is provided on the connected support 3, and an upper end face and a lower end face of the connected support are provided with an upper heat insulation block 2 and a lower heat insulation block 4, respectively. The lower heat insulation block 4 is provided with a limit hole 41 connecting the bolt mounting hole, and the upper heat insulation block 3 is extended with a limit sleeve 21 inserted in the limit hole 41. The lower end face of the connected support 3 is lapped on the base 5 through the lower heat insulation block 4, and the upper end face and a nut of the bolt 1 are supported by the upper heat insulation block 2. The limit hole 41 and the limit sleeve 21 are provided between the upper heat insulation block 2 and the lower heat insulation block 4, and the limit sleeve 21 is inserted in the limit hole 41. The bolt 1 is locked on the base 5 through the upper heat insulation block 2, connected support 3, and the lower heat insulation block 4. The supported support 3 is clamped between the upper heat insulation block 2 and the lower heat insulation block 4 by an insertion structure between the upper heat insulation block 2 and the lower heat insulation block 4, and an inner wall of a bolt hole on the connected support 3 is insulated by the limit sleeve 21, so as to realize effective heat insulation of the connected support and reduce heat losses of the connected support 3.

In one embodiment, the bolt mounting hole, limit hole 41, and the limit sleeve 21 are arranged coaxially. The upper heat insulation block 2 is extended into the bolt hole of the connected support 3 from the limit sleeve 21. It is easy to generate vibration because the upper heat insulation block 2 and the lower heat insulation block 4 are added between the connected support 3 and the base 5, and the support height is increased. The bolt mounting hole, limit hole 41, and limit sleeve 21 are arranged coaxially, so as to improve the radial butting stability of the bolt 1.

Furthermore, the outer wall of the limit sleeve 21 is closely matched with the inner wall of the limit hole 41. The limit sleeve 21 of the upper heat insulation block 2 is extended into the limit hole 41 of the lower heat insulation block 4, and the limit sleeve 21 and the limit hole 41 are arranged in interference fit so that the two parts are closely combined after compressing the connected support 3, in order to further avoid the problem that the support structures of the upper heat insulation block 2 and lower heat insulation block 4 are loose due to environmental vibration. To avoid the problem that the lower heat insulation block 4 is extruded and cracked after the upper heat insulation block 2 and the lower heat insulation block 4 are inserted, the interference fit value of the two should be less than the maximum deformation of the two, so as to further improve the use safety.

In an embodiment of this invention, the inner hole of the limit sleeve 21 is closely matched with the outer ring of the bolt 1. Mounting holes matched with the bolt 1 are provided both on the upper heat insulation block 2 and the lower heat insulation block 4, and the bolt hole on the upper heat insulation block 2 is an inner hole coaxially arranged with the limit sleeve 21. A bolt connection hole closely matched with the outer ring of the bolt 1 is provided on the lower heat insulation block 4, and the bolt connection hole of the lower heat insulation block 4 is the bolt connection hole coaxially arranged with the limit hole 41. The inner hole of the limit sleeve 21 and the bolt connection hole on the lower heat insulation block 4 are both closely matched with the outer ring of the bolt 1, so as to further ensure the connection stability.

The upper heat insulation block 2 and the lower heat insulation block 4 are both mica heat insulation blocks. The upper heat insulation block 2 and the lower heat insulation block 4 both made from mica have lower heat conductivity coefficient and outstanding pressure resistance, in order to ensure that there is no contact or heat transfer channel between the connected support 3 of the high temperature part and the low temperature fixing base 5; such lower heat conductivity coefficient can ensure the heat insulation performance of this structure, and stronger pressure resistance can ensure the fixing function of this structure, consequently to ensure that this structure can effectively reduce heat losses while ensuring the reliability.

Based on the cold-hot component support structure provided by the foregoing embodiments, the present invention also provides an SOFC heat insulation support structure, comprising a mounting support for erecting an SOFC and a mounting base for erecting the support, wherein the cold-hot component support structure provided according to the foregoing embodiments is provided between the mounting support and the mounting base.

The cold-hot component support structure of the foregoing embodiments is adopted in the SOFC heat insulation support structure, so the advantageous effects brought by the cold-hot component support structure of the SOFC heat insulation support structure are as shown in the foregoing embodiments.

Various modifications to these embodiments will be apparent. The general principle defined herein can be implemented in other embodiments without departing from the scope of the present invention.

1. A cold-hot component support structure, comprising:
a base and
a connected support connected on the base by a bolt, wherein a bolt mounting hole is provided on the connected support, and an upper end face and a lower end face of the connected support are provided with an upper heat insulation block and a lower heat insulation block respectively; and
wherein the lower heat insulation block is provided with a limit hole connecting the bolt mounting hole, and the upper heat insulation block is extended with a limit sleeve inserted in the limit hole.

2. The cold-hot component support structure according to claim 1, wherein the bolt mounting hole, the limit hole, and the limit sleeve are arranged coaxially.

3. The cold-hot component support structure according to claim 1,
wherein an outer wall of the limit sleeve is closely matched with an inner wall of the limit hole.

4. The cold-hot component support structure according to claim 3, wherein an inner hole of the limit sleeve is closely matched with an outer ring of the bolt.

5. The cold-hot component support structure according to claim 4, wherein a bolt connection hole is closely matched with the outer ring of the bolt is provided on the lower heat insulation block.

6. The cold-hot component support structure according to claim 1, wherein the upper heat insulation block and the lower heat insulation block are both mica heat insulation blocks.

7. An SOFC heat insulation support structure, comprising:
a mounting support for erecting an SOFC; and
a mounting base for erecting the support;
wherein the cold-hot component support structure of claim 1 is provided between the mounting support and the mounting base.
